(19) United States
(12) Patent Application Publication
(10) Pub. No.: US 2022/0012214 A1
(43) Pub. Date: Jan. 13, 2022

(54) Techniques and Architectures for Utilizing a Change Log to Support Incremental Data Changes

(71) Applicant: salesforce.com, inc., San Francisco, CA (US)

(72) Inventors: Zhidong Ke, Milpitas, CA (US); Kevin Terusaki, Palo Alto, CA (US); Yifeng Liu, Palo Alto, CA (US); Utsavi Benani, Fremont, CA (US); Heng Zhang, San Jose, CA (US); Aaron Zhang, Richmond Hill (CA); Shreedhar Sundaram, San Mateo, CA (US); Mahalaxmi Sanathkumar, San Francisco, CA (US)

(21) Appl. No.: 16/922,986

(22) Filed: Jul. 7, 2020

(51) Int. Cl. G06F 16/18; G06F 16/174; G06F 16/17; G06F 16/176; G06F 16/22; G06F 11/07

(52) U.S. Cl. CPC G06F 16/1865; G06F 16/1756; G06F 11/0772; G06F 16/1767; G06F 16/2282; G06F 16/1734

(57) ABSTRACT

Techniques and mechanisms for incremental data ingestion are disclosed. Raw data is received from multiple disparate sources to be consumed in an environment for collecting unformatted raw data. The environment has at least a delta data table and a delta notification table. A write to an entry in the delta data table is attempted. Entries to the delta data table specify at least records indicating changes to objects in the environment. A write a corresponding entry to the delta notification table is attempted in response to a successful write attempt to the delta data table. The delta notification table entry includes information about delta data table entries for a specified period. At least one data consumer is notified that the delta data table has been modified.

### TECHNICAL FIELD

Embodiments relate to techniques for managing large quantities of data from disparate sources. More particularly, embodiments relate to techniques for providing and managing incremental information about changes to large data stores.

### BACKGROUND

A “data lake” is a collection data from multiple sources and is not stored in a standardized format. Because of this, collection of the data in the data lake is not as systematic and predictable as more structured collections of data. Thus, many of the tools that are utilized to manage data in a data lake (or other data collection structures) do not (or cannot) provide the desired level of notification and management.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture to provide incremental change information in a data lake environment.

FIG. 2 is a conceptual illustration of one embodiment of entries to a delta data table and to a delta notification table at different ingestion times.

FIG. 3 is a flow diagram of an example embodiment of a technique to provide incremental change information in a data lake environment.

FIG. 4 is a block diagram of one embodiment of a processing resource and a machine readable medium encoded with example instructions to provide incremental change information in a data lake environment.

FIG. 5 is a block diagram of an example environment in which incremental change information in a data lake environment can be provided.

FIG. 6 illustrates a block diagram of an environment where an on-demand database service might be used.

FIG. 7 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In the description that follows a shared activity store (SAS) can function as a data lake to collect raw data from any number of disparate data sources to be utilized by any number of data consumers. As the environment that the SAS serves grows the volume of data to be ingested and managed grows, so an efficient scalable mechanism for managing the SAS data is highly desirable. In some embodiments when there is any insertion, update or deletion to data in the SAS incremental change information can be provided to one or more downstream data consumers. Various techniques and mechanisms for accomplishing this goal are described below. In embodiments within a multitenant environment, the SAS can support a query for updates per organization.

In various embodiments, downstream data consumers can be alerted when changes are made to a partition corresponding to the data consumer. For example, when new date is inserted into a partition or records within a partition are updated or deleted. In some example embodiments, notification to the data consumer(s) can include an organization identifier (OrgID) and a change or modification time/date (e.g., engagementDate in Salesforce platforms) or other timestamp information. Additional and/or different information can be provided in alternate embodiments. The downstream data consumers can use this information to query the SAS for partitions that have changed.

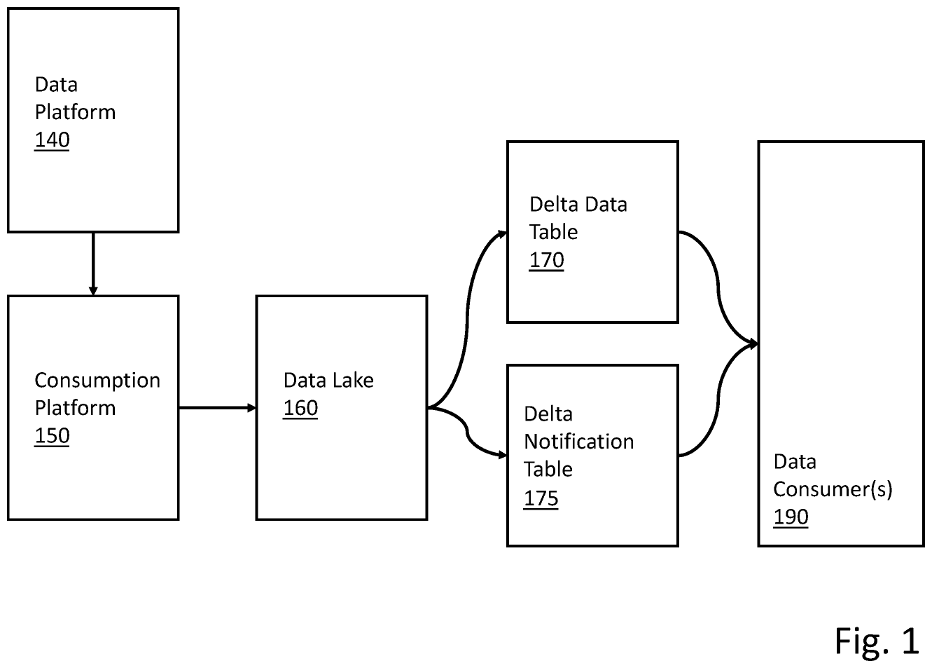

FIG. 1 is a block diagram of one embodiment of an architecture to provide incremental change information in a data lake environment. The block diagram of FIG. 1 provides a data management mechanism that can be utilized to manage data in a data lake (or other collection of data). One example of a data lake is the SAS discussed above. The mechanism of FIG. 1 provides the ability to manage and provide access to modifications of data in a data lake or similar data repository.

Data platform 140 can provide a structure for handling large data loads. For example, in some embodiments, data platform 140 can be provided utilizing Apache Kafka (or similar architecture). Apache Kafka is an open source platform available from Apache Software Foundation based in Wakefield, Mass., USA. Other stream processing and/or message broker platforms can be utilized in different embodiments.

Continuing with the Kafka example, Kafka provides a unified, high-throughput, low-latency platform for handling real-time data feeds. Kafka is based on a commit long concept and allows data consumers to subscribe to data feeds to be utilized by the consumer, and can support real-time applications. In operation, Kafka stores key-value messages from any number of producers, and the data can be partitioned into topic partitions that are independently ordered. Consumers can read messages from subscribed topics.

Data platform 140 functions to gather various types of raw data from any number of data sources (not illustrated in FIG. 1). These data sources can include, for example, data received via graphical user interfaces (GUIs), location data (e.g., global positioning system (GPS) data), sensor data, retrieved data, etc. Any type of data from any number of disparate data sources can provide data to be gathered via data platform 140.

Consumption platform 150 can provide a mechanism to consume data from data platform 140 and manage ingestion of the data to data lake 160. In some embodiments, consumption platform 150 is a distributed cluster-computing framework that can provide data parallelism and fault tolerance. For example, in some embodiments, consumption platform 150 can be provided utilizing Apache Spark (or similar architecture). Apache Spark is an open source platform available from Apache Software Foundation based in Wakefield, Mass., USA. Other consumption platforms and/or data management mechanisms can be utilized in different embodiments.

Continuing with the Spark example, Spark provides an open source distributed general purpose cluster computing framework with an interface for programming clusters with parallelism and fault tolerance. Spark can be used for streaming of data from data platform 140 to data lake 160. Thus, in various embodiments, large numbers of parallel Spark jobs can be utilized to ingest data to data lake 160.

Data lake 160 functions to store data acquired via data platform 140 and managed/routed by consumption platform 150. As described in greater detail below, the processing pipeline for data lake 160 can provide incremental change information corresponding to partitions, organizations and/or other structures. In various embodiments, data ingestion can be provided by parallel streaming jobs (e.g., Spark streaming jobs) that can function to consume data in real time (or near real time).

In one embodiment, one of the streaming jobs writes a file to delta data table 170 with changes to data in data lake 160. In some example embodiments, the file name utilized for the newly written file can include time stamp information and organization/partition identification information. In some embodiments, a time stamp can be rounded down to a specific hour (or other time increment). For example, 2019_09-20-02 can be rounded to 1568944800000. The rounding increment can be based on, for example, a trigger interval for the streaming jobs.

In various embodiments, the files written to delta data table 170 can include multiple records. For example, multiple incremental changes to a partition (or other organizational structure) can be collected as records (or objects) and the records (or objects) corresponding to changes during the current interval can be collected and written to delta data table 170 as a single file. In some embodiments, file can be split if the file size would exceed a pre-selected threshold. Thus, multiple files may be written for a single time interval.

In one embodiment, another streaming job writes a file to delta notification table 175 with information related to a corresponding file written to delta data table 170. The file(s) written to delta notification table 175 include at least identification information for the files in delta data table 170 corresponding to changes over the pre-selected interval.

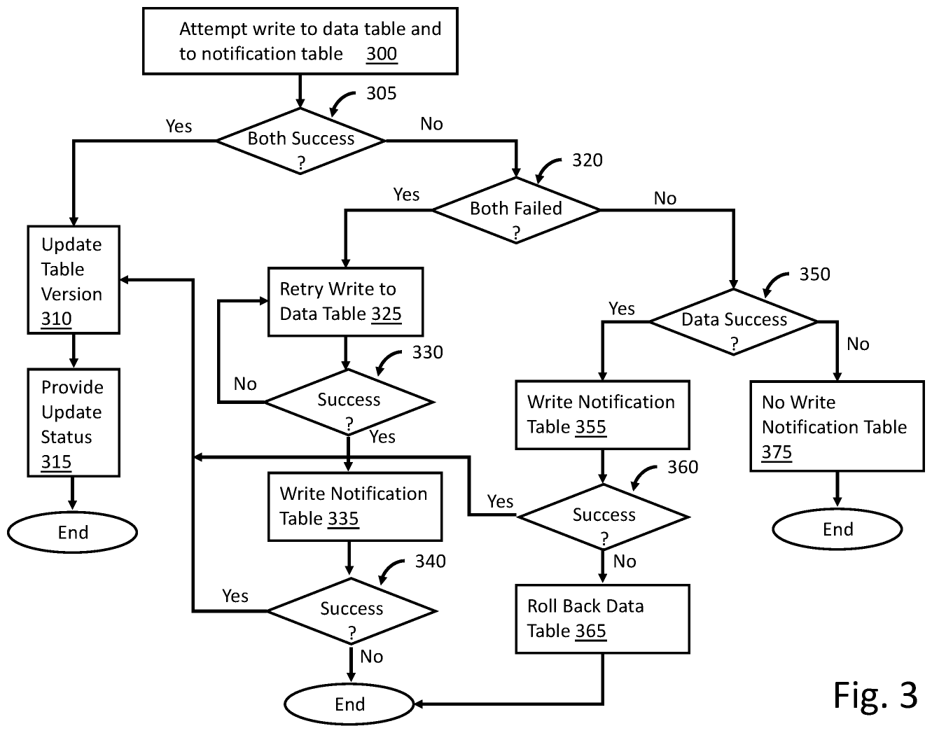

In one embodiment, in order to provide this management of incremental data changes, the following four scenarios are supported: 1) writes to both delta data table 170 and delta notification table 175 are successful; 2) the write to delta data table 170 is successful and the write to delta notification table 175 is unsuccessful; 3) the write to delta data table 170 is unsuccessful an the write to delta notification table 175 is successful; and 4) the writes to both delta data table 170 and delta notification table 175 are unsuccessful. An example technique for managing these four scenarios is provided below with respect to FIG. 3.

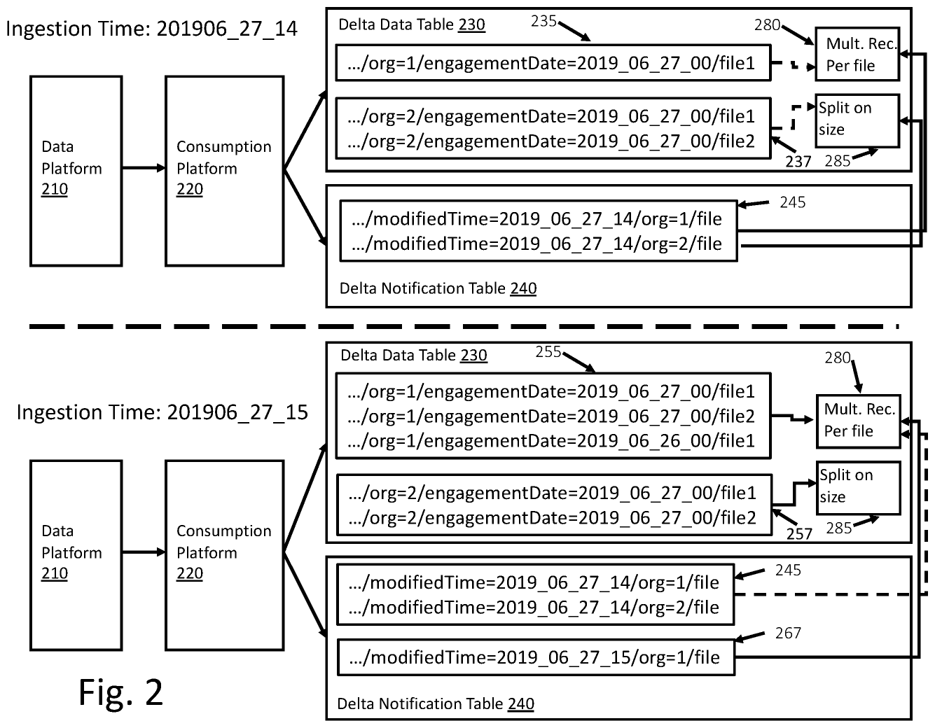

FIG. 2 is a conceptual illustration of one embodiment of entries to a delta data table and to a delta notification table at different ingestion times. The architecture of FIG. 2 provides a mechanism for gathering data from various sources (not illustrated in FIG. 2) and handling the ingestion of the data in the manner described above. Various use cases are provided herein; however, the architectures and mechanisms may be more broadly applicable than these use cases.

In various embodiments, data platform 210 can be part of (or communicatively coupled with) a data lake that can absorb many types of raw data. The data can be, for example, user input from a graphical user interface (GUI), device movements (e.g., mouse, trackpad, eye tracking, gestures), browsing history, operating system information, security profiles, or any other type of data.

Consumption platform 220 can manage the flow of data from data platform 210 to any number of end consumers (not illustrated in FIG. 2) utilizing delta data table 230 and delta notification table 240. The example of FIG. 2 illustrates example states of delta data table 230 and delta notification table 240 at a first ingestion time (e.g., 20190627_14) and at a second ingestion time (e.g., 20190627_15).

In the example of FIG. 2, file names are utilized to organize files containing records that have been changed based on organization (or other member of a larger group) and modification time (not ingestion time). Thus, a file name can be, for example:
. . . OrgID={OrgID}/ModifiedDate={rounded timestamp}/name
   In one embodiment, the time stamp is rounded down to the previous hour, but other techniques for utilizing the time stamp can be utilized.

In the embodiments utilizing this type of directory hierarchy data is partitioned by organization and action time. By partitioning by action time (e.g., engagement time, modification time) duplicate actions can be grouped under the same partition.

The example of FIG. 2 illustrates, for the first ingestion time (i.e., 201906_27_14), files written to delta data table 230 for two organizations; however, any number of organizations can be supported. For the first organization, a single file (e.g., 235; “ . . . org=1/engagementDate=2019_06_27_00/file1 . . . ”) is written to delta data table 230. Each file can contain multiple records (e.g., 280). For the second organization, multiple files (e.g., 237; “ . . . org=2/engagementDate=2019_06_27_00/file1 . . . ” and “ . . . org=2/engagementDate=2019_06_27_00/file2 . . . ”) are written to delta data table 230. Files can be split (e.g., 285) when the required file size exceeds some pre-selected threshold value.

In one embodiment, after insertion to delta data table 230, notification data to be written to delta notification table 240 can be generated. In the example embodiments, files written to delta notification table 240 utilize a similar organization and action time structure (e.g., 245; “modifiedTime=2019_06_27_14/org=1/file . . . ” and “modifiedTime=2019_06_27_14/org=2/file . . . ”) so that when consumers query delta notification table 240, the new files (since the last query) can be determined. With this information, the consumer(s) can read the incremental data from delta data table 230.

At the subsequent ingestion time (i.e., 201906_27_15), files are written to delta data table 230 to indicate changes and/or events that are ingested after the first ingestion time. Files are written to delta data table 230 utilizing the same structure as for the first ingestion time (e.g., 255; “ . . . org=1/engagementDate=2019_06_27_00/file2 . . . ” and “ . . . org=1/engagementDate=2019_06_26_00/file1 . . . ”). Similarly, notification data files (e.g., 267; “modifiedTime=2019_06_27_15/org=1/file . . . ”) are written to delta notification table 240.

Updates and deletions can be handled in a similar manner. When a job applies an update or deletion to delta data table 230, it can also generate a notification message including the date/time and organization, and insert that information into delta notification table 240, which will provide notification to any downstream consumer of data.

Thus, by utilizing the structures and techniques illustrated in FIGS. 1 and 2, using a delta notification table and partitioning by organization (or data source) and date (or time) the consumers of data can query and retrieve incremental data from a data lake environment. Further, consumers can query specific updates for specific organizations, which provides a more efficient and more secure data lake environment.

FIG. 3 is a flow diagram of an example embodiment of a technique to provide incremental change information in a data lake environment. The flow illustrated in FIG. 3 can be provided within the context of the architecture of FIG. 1. As discussed above, parallel streaming jobs can be utilized to write to a delta data table and a delta notification table in parallel in order to provide incremental change information in a data lake environment.

As described above, this can be accomplished utilizing Apache Kafka and Apache Spark. In alternate embodiments, other specific mechanisms for gathering and ingesting data can be utilized to perform the functionality described with respect to FIG. 3.

The streaming job(s) attempt to write both to the delta data table (e.g., 170) and to the delta notification table (e.g., 175), 300. As discussed above, this can be accomplished via a Spark job or similar mechanism. If the write to the delta data table and the write to the delta notification table are successful, 305, then the delta data table version is updated, 310 and a status update or notification can be provided, 315, to allow one or more downstream data consumers to be informed of the successful writes.

If both the write to the delta data table and the write to the delta notification table are not successful, 305, because both the write to the delta data table and the write to the delta notification table have failed, 320, then the write to the delta data table is retried a pre-selected (e.g., 2, 10, 14, 37) number of times, 325. If one of the retries is successful, 330, then another attempt can be made to write the delta notification table, 335. If the write to the delta notification table is successful, 340, then the delta data table version is updated, 310 and a status update or notification can be provided, 315, to allow one or more downstream data consumers to be informed of the successful writes. If the write to the delta notification table is not successful, 340, then the process can end.

If both the write to the delta data table and the write to the delta notification table are not successful, 305, because one of the write to the delta data table and the write to the delta notification table have failed, 320, then if the write to the delta data table was successful, 350, the write to the delta notification table is retried, 355. In some embodiments, a pre-selected number of retries can be attempted before determining success or failure (e.g., 360).

If the retried write to the delta notification table is successful, 360, then the delta data table version is updated, 310 and a status update or notification can be provided, 315, to allow one or more downstream data consumers to be informed of the successful writes. If the retried write to the delta notification table is not successful, 360, then the delta data table can be rolled back, 365, and the process can end.

If both the write to the delta data table and the write to the delta notification table are not successful, 305, because one of the write to the delta data table and the write to the delta notification table have failed, 320, then if the write to the delta data table was not successful, 350, there is no write to the delta notification table, 375. The process can then end.

In summary, if writes to both the delta data table and delta notification table are successful, the version of the delta data table is increased and the downstream data consumer(s) is/are notified via an update to the delta notification table. If writes to both the delta data table and the delta notification table both fail, the write to the delta data table can be retried because the delta data table write is attempted prior to the delta notification table write.

If, after a pre-selected number of retries the write to the delta data table still fails the operation can be terminated and no writes occur to either the delta data table or the delta notification table for the current transaction. The table versions will be unchanged so the downstream consumers will have no indication of new data.

In some embodiments, if the write to the delta data table is successful and the write to the delta notification table fails, the version of the delta data table is increased but the delta data table is rolled back to its previous state because the atomic transaction cannot be completed due to the failure of the write to the delta notification table. No downstream consumer notification is provided. If the write to the delta data table fails and the write to the delta notification table succeeds (or could succeed), the version of the delta data table is not increased and the data is not written to the delta notification table. No downstream consumer notification is provided.

Thus, only when the writes to both the delta data table and the delta notification table are successful will the downstream data consumer be notified of the newly available data. Otherwise, the downstream data consumer will not see any changes. The result is the ability to provide an incremental update from the perspective of the downstream consumer within an environment in which data can be ingested from multiple disparate sources having different data formats.

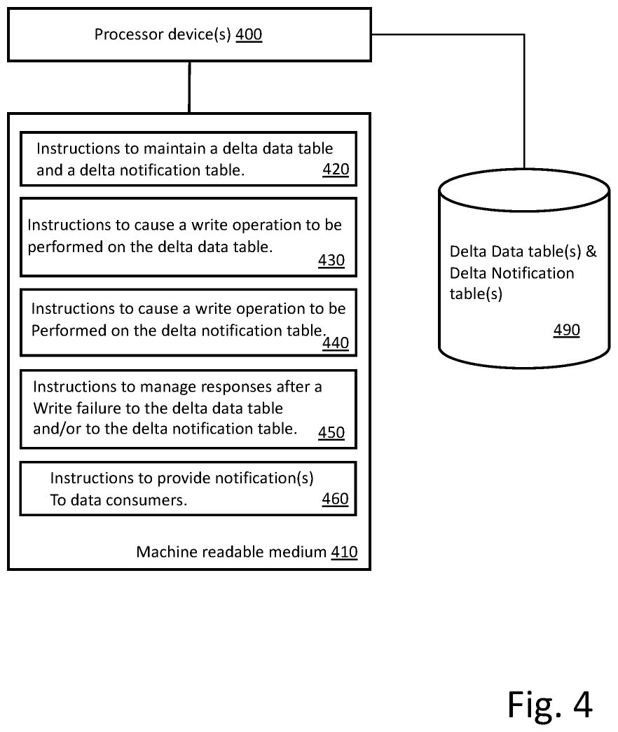

FIG. 4 is a block diagram of one embodiment of a processing resource and a machine readable medium encoded with example instructions to provide incremental change information in a data lake environment. Machine readable medium 410 is non-transitory and is alternatively referred to as a non-transitory machine readable medium 410. In some examples, the machine readable medium 410 may be accessed by processor device(s) 400. Processor device(s) 400 and machine readable medium 410 may be included in computing nodes within a larger computing architecture.

Machine readable medium 410 may be encoded with example instructions 420, 430, 440, 450 and 460. Instructions 420, 430, 440, 450 and 460, when executed by the processor device(s) 400, may implement various aspects of the techniques for providing atomic transactions as described herein.

In some embodiments, instructions 420 cause processor device(s) 400 to maintain the delta data table and the delta notification table. The delta data table(s) and delta notification table(s) can be maintained on storage device(s) 490. As discussed above, multiple delta data tables and delta notification tables can be maintained and utilized in parallel. In some embodiments, at least a portion of the delta data table and delta notification table functionality can be provided in association with open source components (e.g., KAFKA, SPARK). In other embodiments, instructions 420 can provide all of the table functionality. In some embodiments, the described functionality is provided within a multitenant on-demand services environment.

In some embodiments, instructions 430 cause processor device(s) 400 to cause a write operation to be performed on the delta data table(s). As discussed above, data to be ingested and consumed by downstream consumers (not illustrated in FIG. 4) is written to a delta data table as part of the incremental update process. In some embodiments, the write to the delta data table happens before the write to the delta notification table. As described with respect to the flow diagram of FIG. 3, under certain conditions, the write to the delta data table may be retried. Thus, in some embodiments, feedback from the write operation may be utilized for subsequent instruction functionality.

In some embodiments, instructions 440 cause processor device(s) 400 to cause a write operation to the delta notification table. As discussed above, the write to the delta data table happens before (or concurrently with) the write to the delta notification table. As described with respect to the flow diagram of FIG. 3, the handling of the write to the delta notification table can be dependent upon the success or failure of the write operation to the delta data table.

In some embodiments, instructions 450 cause processor device(s) 400 to manage responses after a failure to write to the delta data table and/or a failure to write to the delta notification table. As discussed above, various responses can be initiated in response to a write failure. The example flow of FIG. 3 provides mechanisms for handling write failures to the delta data table and/or to the delta notification table. Alternative embodiments can also be supported.

In some embodiments, instructions 460 cause processor device(s) 400 to maintain the delta data table and the delta notification table. As discussed above, in response to successful writes to both the delta data table and the delta notification table an update or other indication is provided to downstream (in the data ingestion stream) consumers to allow the consumers to act on the newly available data. In some embodiments, consumers may be notified that the delta data table and/or the delta notification table have been updated. In other embodiments, the consumers may periodically check the delta notification table to determine whether any updates have occurred. A combination can also be supported.

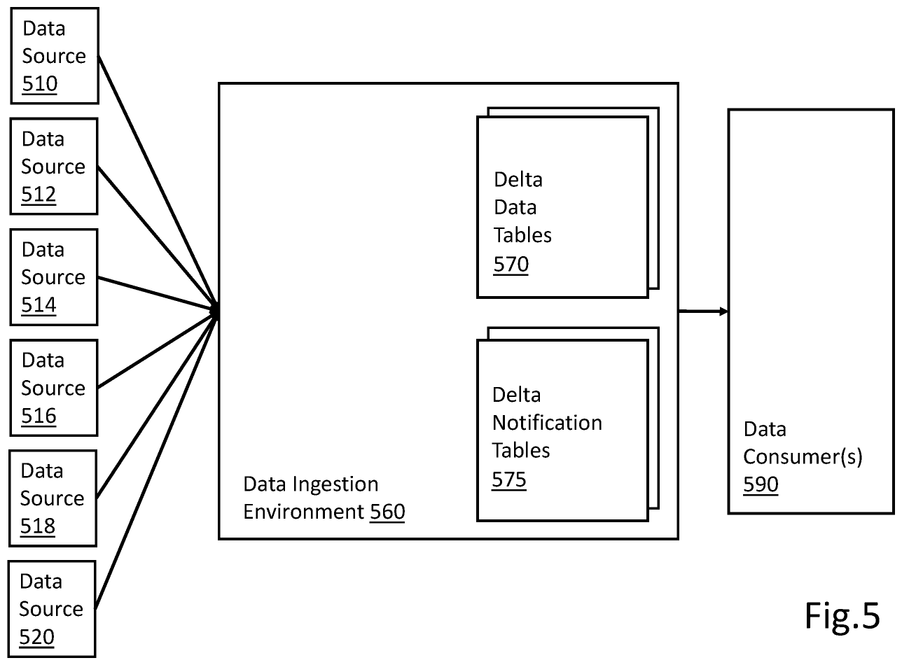

FIG. 5 is a block diagram of an example environment in which incremental change information in a data lake environment can be provided. The architecture of FIG. 5 provides a mechanism for gathering data from various sources and handling the ingestion of the data in the manner described above. Various use cases are provided herein; however, the architectures and mechanisms may be more broadly applicable than these use cases.

Any number of data sources (e.g., 510, 512, 514, 516, 518, 520) can be communicatively coupled with data ingestion environment 560 to provide various types of data. As discussed above, data ingestion environment 560 can be part of (or communicatively coupled with) a data lake that can absorb many types of raw data. The data can be, for example, user input from a graphical user interface (GUI), device movements (e.g., mouse, trackpad, eye tracking, gestures), browsing history, operating system information, security profiles, or any other type of data.

Data ingestion environment 560 can receive data from the various data sources and can write the data to one or more sets of data tables and notification tables as described herein. In some embodiments, for example, data ingestion environment 560 can maintain a data path for user input through a specific GUI (that may be accessed by multiple users on multiple devices), and a data table and a corresponding notification table can be utilized to write the user input as an atomic transaction to be consumed by one or more data consumers 590.

Data consumers 590 can be any type of device/entity that utilizes the data gathered by data ingestion environment 560. A data consumer can be, for example, a customer relationship management (CRM) platform that analyses and manages information and communications corresponding to various sales flows. A data consumer can be, for example, an artificial intelligence (AI) platform that predicts market conditions based on gathered data.

As mentioned above, one or more of the components discussed can be part of a multitenant on-demand services environment. In this example, various domains can be supported within the environment. For example, a sales domain may provide user input related to sales processes and an analytics domain may operate on data gathered from the sales domain and/or data from other domains. Thus, the atomic transactions described herein can be used to support complex data flows between many different types of data sources and many different types of data consumers.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

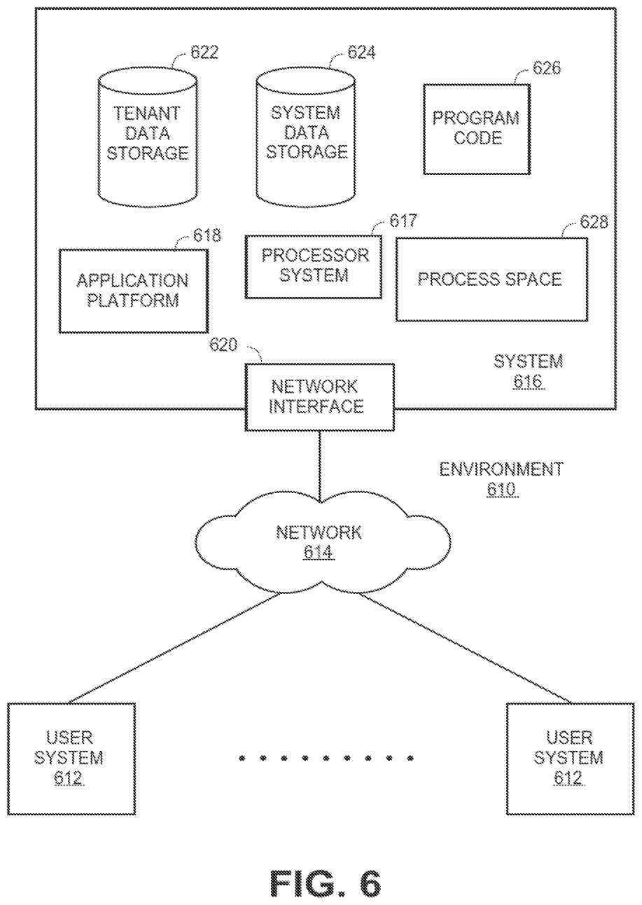

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

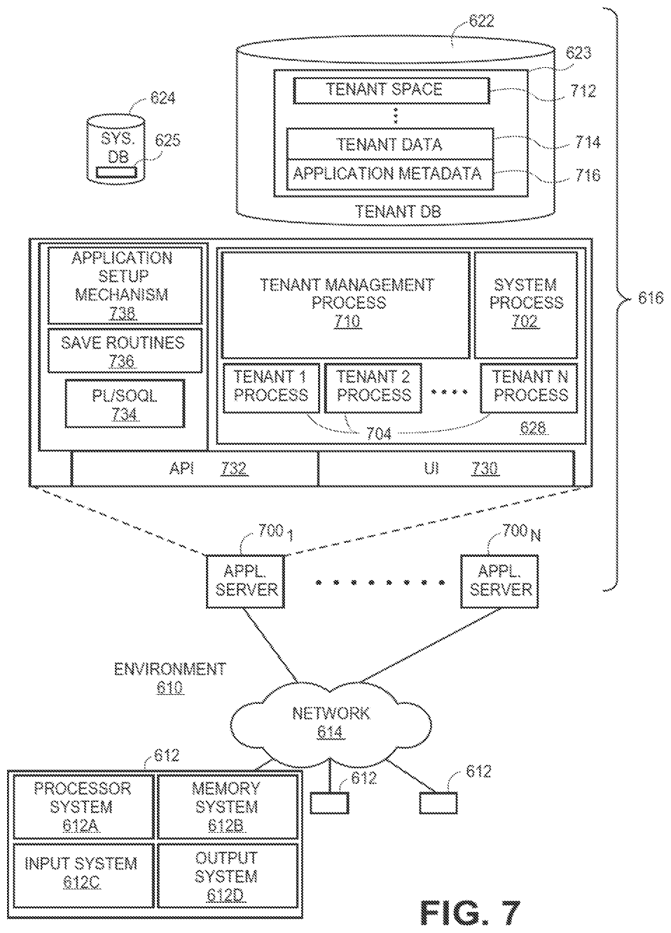

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core series processor or the like. Similarly, system 616 (and additional instances of an MTS, where more than one is present) and all of their components might be operator configurable using application(s) including computer code to run using a central processing unit such as processor system 617, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 BIG-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for ingesting data through an atomic transaction, the method comprising:
receiving raw data from multiple disparate sources to be consumed in an environment for collecting unformatted raw data, the environment having at least a delta data table and a delta notification table;
attempting to write an entry to the delta data table, wherein entries to the delta data table specify at least records indicating changes to objects in the environment;
attempting to write a corresponding entry to the delta notification table in response to a successful write attempt to the delta data table, wherein the delta notification table entry comprises information about delta data table entries for a specified period;
notifying at least one data consumer that the delta data table has been modified.

2. The method of claim 1 further comprising:
retrying the write to the delta data table a pre-selected number of times or until the write is successful; and
generating an indication of failure in response to the pre-selected number of unsuccessful write attempts.

3. The method of claim 1 further comprising rolling back the delta data table in response to successful writing of the delta data table entry and failure of the writing of the delta notification table entry.

4. The method of claim 1 wherein data to be consumed is received from multiple data sources having disparate native data formats.

5. The method of claim 4 further comprising storing the data in the delta data table entries in the native data format corresponding to an originating data source.

6. The method of claim 1 further comprising managing multiple delta data tables and multiple corresponding delta notification tables to receive data from multiple disparate data sources concurrently.

7. A non-transitory computer-readable medium having stored thereon instructions that, when executed by one or more processors, are configurable to cause the one or more processors to:
receive raw data from multiple disparate sources to be consumed in an environment for collecting unformatted raw data, the environment having at least a delta data table and a delta notification table;
attempt to write an entry to the delta data table, wherein entries to the delta data table specify at least records indicating changes to objects in the environment;
attempt to write a corresponding entry to the delta notification table in response to a successful write attempt to the delta data table, wherein the delta notification table entry comprises information about delta data table entries for a specified period;
notify at least one data consumer that the delta data table has been modified.

8. The non-transitory computer-readable medium of claim 7 further comprising instructions that, when executed by the one or more processors, are configurable to cause the one or more processors to:
retry the write to the delta data table a pre-selected number of times or until the write is successful; and
generate an indication of failure in response to the pre-selected number of unsuccessful write attempts.

9. The non-transitory computer-readable medium of claim 7 further comprising instructions that, when executed by the one or more processors, are configurable to cause the one or more processors to roll back the delta data table in response to successful writing of the delta data table entry and failure of the writing of the delta notification table entry.

10. The non-transitory computer-readable medium of claim 7 wherein data to be consumed is received from multiple data sources having disparate native data formats.

11. The non-transitory computer-readable medium of claim 10 further comprising instructions that, when executed by the one or more processors, are configurable to cause the one or more processors to store the data in the delta data table entries in the native data format corresponding to an originating data source.

12. The non-transitory computer-readable medium of claim 7 further comprising instructions that, when executed by the one or more processors, are configurable to cause the one or more processors to manage multiple delta data tables and multiple corresponding delta notification tables to receive data from multiple disparate data sources concurrently.

13. A system comprising:
a memory system;
one or more hardware processors coupled with the memory system, the one or more hardware processors configurable to receive raw data from multiple disparate sources to be consumed in an environment for collecting unformatted raw data, the environment having at least a delta data table and a delta notification table, to attempt to write an entry to the delta data table, wherein entries to the delta data table specify at least records indicating changes to objects in the environment, to attempt to write a corresponding entry to the delta notification table in response to a successful write attempt to the delta data table, wherein the delta notification table entry comprises information about delta data table entries for a specified period, to notify at least one data consumer that the delta data table has been modified.

14. The system of claim 13 further comprising:
retrying the write to the data table a pre-selected number of times or until the write is successful; and
generating an indication of failure in response to the pre-selected number of unsuccessful write attempts.

15. The system of claim 13 further comprising rolling back the data table in response to successful writing of the data table entry and failure of the writing of the notification table entry.

16. The system of claim 13 wherein data to be consumed is received from multiple data sources having disparate native data formats.

17. The system of claim 16 further comprising storing the data in the data table entries in the native data format corresponding to an originating data source.
